(19) United States
(12) Patent Application Publication
(10) Pub. No.: US 2018/0146256 A1
(43) Pub. Date: May 24, 2018

(54) METHOD AND DEVICE FOR ONLINE MULTIMEDIA PLAYBACK ON USER EQUIPMENT

(71) Applicant: ZHUOYI CHANGXIANG (BEIJING) TECHNOLOGY CO., LTD., Beijing (CN)

(72) Inventors: Huaizhou CUI, Beijing (CN); Junyu WANG, Beijing (CN); Xiangyu ZUO, Beijing (CN); Xiaoyue WU, Beijing (CN); Qiang ZHANG, Beijing (CN); Kai YANG, Beijing (CN)

(73) Assignee: ZHUOYI CHANGXIANG (BEIJING) TECHNOLOGY CO., LTD., Beijing (CN)

(21) Appl. No.: 15/550,910

(22) PCT Filed: Feb. 3, 2016
(86) PCT No.: PCT/CN2016/073278

§ 371 Date: Dec. 1, 2017

(30) Foreign Application Priority Data
Feb. 12, 2015 (CN) 201510074165.8

(51) Int. Cl. H04N 21/472; H04L 29/06; H04L 29/08

(52) U.S. Cl. CPC H04N 21/47217; H04L 67/02; H04L 65/60

(57) ABSTRACT

The present invention provides a method for online multimedia playback on a user equipment. The method has the following steps: when a playback instruction operation executed by a user on playable multimedia displayed on a page is intercepted, launching a second player, the second player being different from the first player instructed by the page to be used for playing back the playable multimedia; playing back the playable multimedia in the second player. According to the solution of the present invention, the playable multimedia displayed on a page may be completely played back in a second player; furthermore, the copyright interests of providers of playable multimedia and providers of advertisement information played in association with playable multimedia are protected.

The present application claims the priority to the Chinese patent application entitled “Method and Device for Online Multimedia Playback on User Equipment”, which was filed on Feb. 12, 2015 with the application number 201510074165.8.

### TECHNICAL FIELD

The present invention relates to the field of computer technology, and particularly to a method and a device for online multimedia playback on user equipment.

### BACKGROUND ART

In the prior art, when a user clicks playable multimedia on a page of user equipment, the user equipment usually launches a player instructed by the page to play back the playable multimedia so as to directly play the playable multimedia on the page.

### DISCLOSURE OF THE INVENTION

An object of the present invention is to provide a method and a device for online multimedia playback on user equipment.

According to one aspect of the present invention, a method for online multimedia playback on user equipment is provided. The method includes the following steps of:

a. launching a second player when a playback instruction operation is intercepted, with the playback instruction operation executed by a user on playable multimedia displayed on a page, wherein the second player is different from a first player instructed by the page to play back the playable multimedia; and

b. playing back the playable multimedia in the second player.

According to another aspect of the present invention, a device for online multimedia playback on user equipment is further provided. The device includes the following means:

launching means, configured for launching a second player when a playback instruction operation is intercepted, with the playback instruction operation executed by a user on playable multimedia displayed on a page, wherein the second player is different from the first player instructed by the page to playing back the playable multimedia; and

playback means, configured for playing back the playable multimedia in the second player.

According to another aspect of the present invention, a browser is further provided. The browser includes the device for online multimedia playback on user equipment as described in the present invention.

Compared with the prior art, the present invention has the following advantages: 1) the user equipment can directly launch the second player to play back the playable multimedia in a full-screen mode, when a playback instruction operation, executed by the user on the playable multimedia displayed on the page, is intercepted (rather than launching full-screen playback after the playback of the playable multimedia has been started on the page), so that the playable multimedia can be played back completely in the second player, thereby improving the user experience and satisfaction; 2) the user equipment can directly launch the second player without launching the first player, so that it is only necessary to install the second player on the user equipment, rather than downloading and installing different types of players or plug-ins with playback functions according to different page requirements; 3) the second player directly plays back the video data corresponding to the obtained playback address information of the playable multimedia, without further parsing the playback address information, thereby the copyright interest of provider of the video data corresponding to the playback address information is protected, the content of the playable multimedia is further ensured to be eco-friendly and the copyright risk is controllable; and 4) it is feasible to provide playback log information of the playable multimedia in the second player to a network device instructed by the page to receive the playback log information, so that the network device can perform data statistics, billing operations (e.g., billing of the playable multimedia, or billing of the advertisement information played back in association with the playable multimedia) etc. on the playback log information, thus the interest of the provider of the playable multimedia, the interest of the provider of the advertisement information, etc. are protected, while the second player is launched to completely play the playable multimedia, so that the copyright risk can be better controlled.

### BRIEF DESCRIPTION OF DRAWINGS

After reading the detailed description made for the non-limiting embodiments with reference to the following drawings, other features, objects and advantages of the present invention will become more obvious.

FIG. 1 is a schematic flow diagram of a method for online multimedia playback on user equipment according to an embodiment of the present invention;

FIG. 2 is a schematic flow diagram of a method for online multimedia playback on user equipment according to another embodiment of the present invention;

FIG. 3 is a schematic structural diagram of a device for online multimedia playback on user equipment according to an embodiment of the present invention; and

FIG. 4 is a schematic structural diagram of a device for online multimedia playback on user equipment according to another embodiment of the present invention.

The same or similar reference signs in the drawings denote the same or similar components.

### DETAILED DESCRIPTION OF EMBODIMENTS

The present invention will be further described below in detail with reference to the drawings.

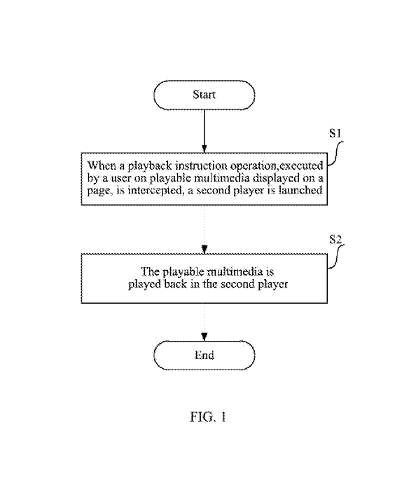

FIG. 1 is a schematic flow diagram of a method for online multimedia playback on user equipment according to an embodiment of the present invention.

The method of the present embodiment is mainly implemented by user equipment. Preferably, the user equipment includes a mobile device, and the mobile device includes, but not limited to, a tablet computer, a smartphone, a PDA, etc.

It should be noted that the user equipment above is described merely as an example. Other existing user equipment or possible future user equipment, if applicable to the present invention, should be also covered by the scope of protection of the present invention and are incorporated herein by reference.

The method according to the present embodiment includes Step S1 and Step S2.

In Step S1, when a playback instruction operation, executed by a user on playable multimedia displayed on a page, is intercepted, the user equipment launches a second player.

The page includes any pages displayed on the user equipment. Preferably, the page includes a mobile page displayed in a mobile device, and the mobile page includes, but not limited to, a web page displayed in a browser of the mobile device, a page displayed in a client installed on the mobile device, etc. More preferably, the mobile page is based on the HTML5 standard.

The playable multimedia includes any multimedia capable of being played on a page. Preferably, the playable multimedia includes, but not limited to, videos, audios, etc.

The second player is different from the first player instructed by the page to play back the playable multimedia. For example, if the playable multimedia is a video, and the first player instructed, by the mobile page displayed in the mobile device, to play back the video is a flash player, the second player is other video player except the flash player.

Preferably, the second player is a default player set in the user equipment or may be selected by the user. For example, when the playback instruction operation executed by the user on the playable multimedia displayed on the page is intercepted, the user equipment may provide to the user the options of a plurality of players that the user equipment supports, and set the player selected by the user as the second player.

The playback instruction operation executed by the user is used for triggering playback of the playable multimedia. Preferably, the playback instruction operation is a click operation executed on the playable multimedia. Preferably, the playback instruction operation may be intercepted by event monitoring. For example, the playback instruction operation such as the click operation may be intercepted by monitoring through JS (JavaScript) a click event directed to the playable multimedia displayed on the page.

It should be noted that in Step S1, the first player may also be launched by the playback instruction operation, but preferably, in the present invention, the launched first player will not display the playable multimedia on the screen. Alternatively, preferably, Step S1 further includes Step S11.

In Step S11, when the playback instruction operation is intercepted, with the playback instruction operation executed by the user on the playable multimedia displayed on a page, the user equipment launches the second player without launching the first player.

For example, when the playback instruction operation, executed by the user on a video “video1” displayed on the mobile page, is intercepted, the user equipment launches other video player (i.e., the second player), without launching the flash player (i.e., the first player) instructed by the mobile page to play back “video1”.

It should be noted that the above examples merely serve the purpose for better describing the technical solutions of the present invention, rather than limiting the present invention. A person skilled in the art should understand that any implementation modes, for launching the second player when the playback instruction operation executed by the user on playable multimedia displayed on a page is intercepted, shall be covered by the scope of the present invention.

In Step S2, the user equipment plays back the playable multimedia in the second player.

Specifically, the user equipment acquires multimedia data corresponding to the playable multimedia and plays back the playable multimedia in the second player. Preferably, the playback may start from the initial multimedia data (i.e., the beginning of the playable multimedia). Preferably, the user equipment plays back the playable multimedia in the second player in a full-screen mode.

As a preferable solution of Step S2, Step S2 further includes Step S21 and Step S22.

In Step S21, the user equipment acquires playback address information of the playable multimedia.

The playback address information is used for indicating an address where the multimedia data corresponding to the playable multimedia is able to be obtained.

The user equipment can acquire the playback address information of the playable multimedia in a plurality of ways.

As an example, the user equipment parses the page, and obtains the playback address information of the playable multimedia on the basis of a video tag obtained by parsing. Preferably, the page is based on the HTML5 standard, and the video tag corresponding to the playback address information is “video src”.

For example, when the user equipment parses the page and the video tag obtained by parsing is as follows: <video src=“http://www.xxx.com/vidio/movie.ogg”>, the playback address information of the playable multimedia is “http://www.xxx.com/vidio/movie.ogg”.

As another example, the user equipment directly intercepts the playback address information obtained by the page for the playback instruction operation.

For example, when the user executes the playback instruction operation on the playable multimedia displayed on the page, the playback address information is obtained on the page for the playback instruction operation, so as to play back the playable multimedia on the basis of the playback address information; and the user equipment directly intercepts the playback address information.

It should be noted that the above examples merely serve the purpose for better describing the technical solutions of the present invention, rather than limiting the present invention. A person skilled in the art should understand that any implementation modes for acquiring the playback address information of the playable multimedia shall be covered by the scope of the present invention.

In Step S22, the user equipment acquires the video data corresponding to the playback address information, and plays back the video data in the second player.

For example, in Step S21, the playback address information of the playable multimedia acquired by the user equipment is address 1; and in Step S22, the user equipment directly acquires the video data corresponding to the playable multimedia from the address indicated by address1, and plays back the acquired video data in the second player.

It should be noted that the above examples merely serve the purpose for better describing the technical solutions of the present invention, rather than limiting the present invention. A person skilled in the art should understand that any implementation modes for playing back the playable multimedia in the second player shall be covered by the scope of the present invention.

In the prior art, when a user clicks the playable multimedia on the page of the user equipment, the user equipment usually launches a player (i.e., the first player), instructed by the page to play back the playable multimedia, to directly play back the playable multimedia on the page. However, in this case, the playable multimedia displayed on the page can only occupy part of the screen, and the screen of the user equipment (especially the mobile device) is usually small. Thus, such playback significantly reduces the visual experience and satisfaction of the user. Therefore, the user needs to click full-screen playing in the first player for launching a new window to play back the playable multimedia in a full-screen mode in the first player.

With the present invention, the following problems are found existing in the prior art: 1) When the user clicks full-screen playing, the first player has already played back the playable multimedia. In addition, when the user equipment launches a new window to play back the playable multimedia in the full-screen mode, the playback operation on the playable multimedia in the page is interrupted, and the user equipment needs to reacquire the video data in the new window according to the position where the playable multimedia is interrupted and continue the playback. 2) Only when the first player instructed by the page has been installed in the user equipment, the playable multimedia can be played back on the page, or the new window can be launched, after the full-screen playing is clicked, to play back the playable multimedia in the full-screen mode in the first player. However, since different pages instruct different first players, a variety of players or plug-ins with playback functions may need to be installed in the user equipment. 3) In the prior art, when full-screen playing is carried out, the playback address information of the playable multimedia is usually further parsed, so as to obtain from other sources multimedia data corresponding to high-quality version of the playable multimedia. Although the implementation mode provides better experience for the user, it seriously affects the copyright interest of the provider of the video data corresponding to the playback address information.

According to the solution of the present embodiment, the user equipment can directly launch the second player to play back the playable multimedia in the full-screen mode, when the playback instruction operation, executed by the user on the playable multimedia displayed on the page, is intercepted (rather than launching full-screen playback after the playback of the playable multimedia has been started on the page), so that the playable multimedia can be played back completely in the second player, thereby improving the user experience and satisfaction. Moreover, the user equipment can directly launch the second player without launching the first player, so that it is only necessary to install the second player on the user equipment, rather than downloading and installing different types of players or plug-ins with playback functions according to different page requirements.

Furthermore, the second player directly plays back the video data corresponding to the obtained playback address information of the playable multimedia, without further parsing the playback address information, thereby the copyright interest of the provider of the video data corresponding to the playback address information is protected, the content of the playable multimedia is further ensured to be eco-friendly and the copyright risk is controllable.

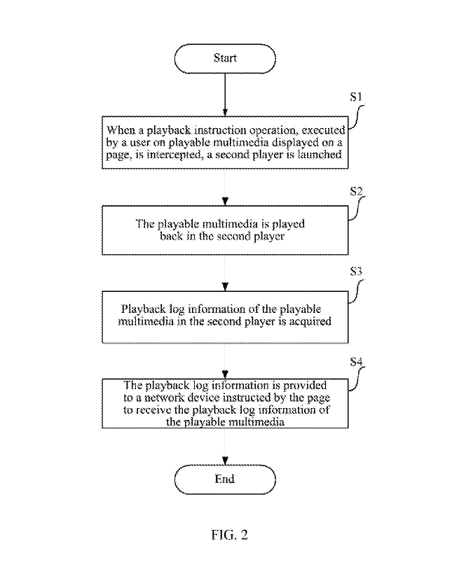

FIG. 2 is a schematic flow diagram of a method for online multimedia playback on user equipment according to another embodiment of the present invention. The method of the present embodiment is mainly implemented by user equipment, and any description made on the user equipment with reference to FIG. 1 is incorporated herein by reference.

The method according to the present embodiment includes Step S1, Step S2, Step S3 and Step S4. Step S1 and step S2 have been described in detail with reference to FIG. 1, and are not further described herein.

In Step S3, the user equipment acquires playback log information of the playable multimedia in the second player.

The playback log information includes any information related to the playback of the playable multimedia in the second player. Preferably, the playback log information includes, but not limited to:

1) Playback time information of the playable multimedia.

Specifically, the playback time information includes any information related to the playback time of the playable multimedia in the second player. Preferably, the playback time information includes, but not limited to, an actual playback time period of the playable multimedia (for example, the playback time information is used for indicating that the actual playback time period of the playable multimedia includes the 0th to 5th minutes and the 7th to 20th minutes of the playable multimedia), the total playback time length of the playable multimedia (for example, the playback time information is used for indicating that the total playback time length of the multimedia information is 30 minutes), etc.

2) Playback record information of advertisement information played in association with the playable multimedia.

Specifically, the playback record information includes any information related to the playback records of the advertisement information. Preferably, the playback record information includes, but not limited to, the content of the advertisement information, the playback time length of the advertisement information, the number of times of playback of the advertisement information, etc.

3) Information of operations executed by the user on the playable multimedia.

Specifically, the information of operation includes any information related to the operations executed by the user on the playable multimedia in the second player. Preferably, the information of operation includes, but not limited to, a fast forward operation, a rewinding operation, a pause operation, etc.

It should be noted that the playback log information above is merely described as an example. Any other information related to the playback of the playable multimedia in the second player shall be covered by the scope of the playback log information of the present invention.

The user equipment can acquire the playback log information of the playable multimedia in the second player in a plurality of ways.

For example, the user equipment directly acquires a log file generated by the second player for the playable multimedia, and generates playback log information according to the log file.

As another example, the user equipment obtains the information of the operations executed by the user on the playable multimedia, by detecting the operations executed by the user on the playable multimedia in the second player.

It should be noted that the above examples merely serve the purpose for better describing the technical solutions of the present invention, rather than limiting the present invention. A person skilled in the art should understand that any implementation modes for acquiring the playback log information of the playable multimedia in the second player shall be covered by the scope of the present invention.

In Step S4, the user equipment provides the playback log information to a network device instructed by the page to receive the playback log information of the playable multimedia.

The network device includes, but not limited to, a single network server, a server group consisting of a plurality of network servers, or a cloud computing-based cloud consisting of a large number of computers or network servers. Specifically, the cloud computing, which is one kind of distributed computing, is a super virtual computer composed of a group of loosely-coupled computer sets. Preferably, the operator of the network device is the provider of the playable multimedia, or the provider of the advertisement information played in association with the playable multimedia.

Preferably, the user equipment parses the page, and calls a function (such as JS function) related to the playback log information on the page according to the parsing result, so as to provide the playback log information to the network device instructed by the page to receive the playback log information of the playable multimedia.

It should be noted that the above examples merely serve the purpose for better describing the technical solutions of the present invention, rather than limiting the present invention. A person skilled in the art should understand that any implementation modes for providing the playback log information to the network device instructed by the page to receive the playback log information of the playable multimedia shall be covered by the scope of the present invention.

According to the solution of the present embodiment, it is feasible to provide playback log information of the playable multimedia in the second player to the network device instructed by the page to receive the playback log information, so that the network device can perform data statistics, billing operations (e.g., billing of the playable multimedia, or billing of the advertisement information played in association with the playable multimedia) etc. on the playback log information. Thus the interest of the provider of the playable multimedia, the interest of the provider of the advertisement information, etc. are protected, while the second player is launched to completely play back the playable multimedia, thus better controlling the copyright risk.

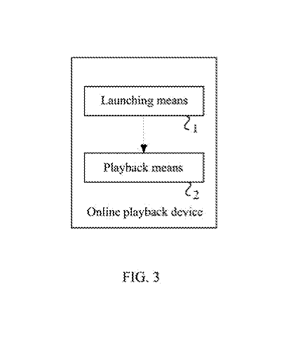

FIG. 3 is a schematic structural diagram of a device for online multimedia playback on user equipment according to an embodiment of the present invention. The device for online multimedia playback (hereinafter referred to as “online playback device”) includes launching means 1 and playback means 2.

When a playback instruction operation, executed by a user on playable multimedia displayed on a page, is intercepted, the launching means 1 launches a second player.

The page includes any pages displayed on the user equipment. Preferably, the page includes a mobile page displayed in a mobile device, and the mobile page includes, but not limited to, a web page displayed in a browser of the mobile device, a page displayed in a client installed on the mobile device, etc. More preferably, the mobile page is based on the HTML5 standard.

The playable multimedia includes any multimedia playable on a page. Preferably, the playable multimedia includes, but not limited to, videos, audios, etc.

The second player is different from the first player instructed by the page to play back the playable multimedia. For example, if the playable multimedia is a video, and the first player instructed, by the mobile page displayed in the mobile device, to play back the video is a flash player, the second player is other video player except the flash player.

Preferably, the second player is a default player set in the user equipment or may be selected by the user. For example, when the playback instruction operation executed by the user on the playable multimedia displayed on the page is intercepted, the user equipment may provide to the user options of a plurality of players that the user equipment supports, and set the player selected by the user as the second player.

The playback instruction operation executed by the user is used for triggering playback of the playable multimedia. Preferably, the playback instruction operation is a click operation executed on the playable multimedia. Preferably, the playback instruction operation may be intercepted by event monitoring. For example, the playback instruction operation, such as the click operation, may be intercepted by monitoring, via JS (JavaScript), a click event directed to the playable multimedia displayed on the page.

It should be noted that the first player may also be launched by the playback instruction operation, but preferably, in the present invention, the launched first player will not display the playable multimedia on the screen. Alternatively, preferably, the launching means 1 further includes sub-launching means (not shown in the figures).

When the playback instruction operation executed by the user on the playable multimedia displayed on a page is intercepted, the sub-launching means launches the second player without launching the first player.

For example, when the playback instruction operation, executed by the user on a video “video1” displayed on the mobile page, is intercepted, the sub-launching means launches other video player (i.e., the second player), without launching the flash player (i.e., the first player) instructed by the mobile page to play back “video1”.

It should be noted that the above examples merely serve the purpose for better describing the technical solutions of the present invention, rather than limiting the present invention. A person skilled in the art should understand that any implementation modes for launching the second player when the playback instruction operation executed by the user on playable multimedia displayed on a page is intercepted shall be covered by the scope of the present invention.

The playback means 2 plays back the playable multimedia in the second player.

Specifically, the playback means 2 acquires multimedia data corresponding to the playable multimedia and plays back the playable multimedia in the second player. Preferably, the playback may start from the initial multimedia data (i.e., the beginning of the playable multimedia). Preferably, the playback means 2 plays back the playable multimedia in the second player in a full-screen mode.

As a preferable solution of the playback means 2, the playback means 2 further includes second acquisition means (not shown in the figures) and third acquisition means (not shown in the figures).

The second acquisition means acquires playback address information of the playable multimedia.

The playback address information is used for indicating an address where the multimedia data corresponding to the playable multimedia is able to be obtained.

The second acquisition means can acquire the playback address information of the playable multimedia in a plurality of ways.

As an example, the second acquisition means further includes parsing means (not shown in the figures). The parsing means parses the page, and obtains the playback address information of the playable multimedia on the basis of a video tag obtained by parsing. Preferably, the page is based on the HTML5 standard, and the video tag corresponding to the playback address information is “video src”.

For example, when the parsing means parses the page, and the video tag obtained by parsing is as follows: <video src=“http://www.xxx.com/vidio/movie.ogg”>, the playback address information of the playable multimedia is “http://www.xxx.com/vidio/movie.ogg”.

As another example, the second acquisition means directly intercepts the playback address information obtained by the page for the playback instruction operation.

For example, when the user executes the playback instruction operation on the playable multimedia displayed on the page, the playback address information is obtained on the page for the playback instruction operation, so as to play back the playable multimedia on the basis of the playback address information; and the second acquisition means directly intercepts the playback address information.

It should be noted that the above examples merely serve the purpose for better describing the technical solutions of the present invention, rather than limiting the present invention. A person skilled in the art should understand that any implementation modes for acquiring the playback address information of the playable multimedia shall be covered by the scope of the present invention.

The third acquisition means acquires the video data corresponding to the playback address information, and plays back the video data in the second player.

For example, the playback address information of the playable multimedia acquired by the second acquisition means is address1; and the third acquisition means directly acquires the video data corresponding to the playable multimedia from the address indicated by address1, and plays back the acquired video data in the second player.

It should be noted that the above examples merely serve the purpose for better describing the technical solutions of the present invention, rather than limiting the present invention. A person skilled in the art should understand that any implementation modes for playing back the playable multimedia in the second player shall be covered by the scope of the present invention.

In the prior art, when a user clicks the playable multimedia on a page of user equipment, the user equipment usually launches a player (i.e., the first player), instructed by the page to play back the playable multimedia, to directly play back the playable multimedia on the page. However, in this case, the playable multimedia displayed on the page can only occupy part of the screen, and the screen of the user equipment (especially the mobile device) is usually small. Thus, such playback significantly reduces the visual experience and satisfaction of the user. Therefore, the user needs to click full-screen playing in the first player for launching a new window to play back the playable multimedia in the first player in full-screen mode.

With the present invention, the following problems are found existing in the prior art: 1) When the user clicks full-screen playing, the first player has already played back the playable multimedia. In addition, when the user equipment launches a new window to play back the playable multimedia in the full-screen mode, the playback operation on the playable multimedia in the page is interrupted, and the user equipment needs to reacquire the video data in the new window according to the position where the playable multimedia is interrupted and continue the playback. 2) Only when the first player instructed by the page has been installed in the user equipment, the playable multimedia can be played back on the page, or the new window can be launched, after the full-screen playing is clicked, to play back the playable multimedia in the full-screen mode in the first player. However, since different pages instruct different first players, a variety of players or plug-ins with playback functions may need to be installed in the user equipment. 3) In the prior art, when full-screen playing is carried out, the playback address information of the playable multimedia is usually further parsed, so as to obtain from other sources the multimedia data corresponding to high-quality version of the playable multimedia. Although the implementation mode provides better experience for the user, it seriously affects the copyright interest of the provider of the video data corresponding to the playback address information.

According to the solution of the present embodiment, the user equipment can directly launch the second player to play back the playable multimedia in the full-screen mode, when the playback instruction operation executed by the user on the playable multimedia displayed on the page is intercepted (rather than launching full-screen playback after the playback of the playable multimedia has been started on the page), so that the playable multimedia can be played back completely in the second player, thereby improving the user experience and satisfaction. Moreover, the user equipment can directly launch the second player without launching the first player, so that it is only necessary to install the second player on the user equipment, rather than downloading and installing different types of players or plug-ins with playing back functions according to different page requirements.

Furthermore, the second player directly plays back the video data corresponding to the obtained playback address information of the playable multimedia, without further parsing the playback address information, thereby the copyright interest of the provider of the video data corresponding to the playback address information is protected, the content of the playable multimedia is further ensured to be eco-friendly and the copyright risk is controllable.

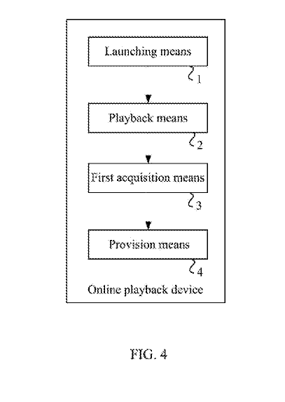

FIG. 4 is a schematic structural diagram of a device for online multimedia playback on user equipment according to another embodiment of the present invention. The online playback device of the present embodiment includes launching means 1, playback means 2, first acquisition means 3 and provision means 4. The launching means 1 and the playback means 2 have been described in detail with reference to FIG. 3, and are not further described herein.

The first acquisition means 3 acquires the playback log information of the playable multimedia in the second player.

The playback log information includes any information related to the playback of the playable multimedia in the second player. Preferably, the playback log information includes, but not limited to:

1) Playback time information of the playable multimedia,

Specifically, the playback time information includes any information related to the playback time of the playable multimedia in the second player. Preferably, the playback time information includes, but not limited to, an actual playback time period of the playable multimedia (for example, the playback time information is used for indicating that the actual playback time period of the playable multimedia includes the 0th to 5th minutes and the 7th to 20th minutes of the playable multimedia), the total playback time length of the playable multimedia (for example, the playback time information is used for indicating that the total playback time length of the multimedia information is 30 minutes), etc.

2) Playback record information of advertisement information played in association with the playable multimedia.

Specifically, the playback record information includes any information related to the playback records of the advertisement information. Preferably, the playback record information includes, but not limited to, the content of the advertisement information, the playback time length of the advertisement information, the number of times of playback of the advertisement information, etc.

3) Information of operations executed by the user on the playable multimedia.

Specifically, the information of operation includes any information related to the operations executed by the user on the playable multimedia in the second player. Preferably, the information of operation includes, but not limited to, a fast forward operation, a rewinding operation, a pause operation, etc.

It should be noted that the playback log information above is merely described as an example. Any other information related to the playback of the playable multimedia in the second player shall be covered by the scope of the playback log information of the present invention.

The first acquisition means 3 can acquire the playback log information of the playable multimedia in the second player in a plurality of ways.

For example, the first acquisition means 3 directly acquires a log file generated by the second player for the playable multimedia, and generates playback log information according to the log file.

As another example, the first acquisition means 3 obtains the information of the operations executed by the user on the playable multimedia, by detecting the operations executed by the user on the playable multimedia in the second player.

It should be noted that the above examples merely serve the purpose for better describing the technical solutions of the present invention, rather than limiting the present invention. A person skilled in the art should understand that any implementation modes for acquiring the playback log information of the playable multimedia in the second player shall be covered by the scope of the present invention.

The provision means 4 provides the playback log information to a network device instructed by the page to receive the playback log information of the playable multimedia.

The network device includes, but not limited to, a single network server, a server group consisting of a plurality of network servers or a cloud computing-based cloud consisting of a large number of computers or network servers. Specifically, the cloud computing, which is one kind of distributed computing, is a super virtual computer composed of a group of loosely-coupled computer sets. Preferably, the operator of the network device is the provider of the playable multimedia, or the provider of the advertisement information played in association with the playable multimedia.

Preferably, the provision means 4 parses the page, and calls a function (such as JS function) related to the playback log information on the page according to the parsing result, so as to provide the playback log information to the network device instructed by the page to receive the playback log information of the playable multimedia.

It should be noted that the above examples merely serve the purpose for better describing the technical solutions of the present invention, rather than limiting the present invention. A person skilled in the art should understand that any implementation modes for providing the playback log information to the network device instructed by the page to receive the playback log information of the playable multimedia shall be covered by the scope of the present invention.

According to the solution of the present embodiment, it is feasible to provide playback log information of the playable multimedia in the second player to the network device instructed by the page to receive the playback log information, so that the network device can perform data statistics, billing operations (e.g., billing of the playable multimedia, or billing of the advertisement information played in association with the playable multimedia) etc. on the playback log information. Thus the interest of the provider of the playable multimedia, the interest of the provider of the advertisement information, etc. are protected, while the second player is launched to completely play back the playable multimedia, thus better controlling the copyright risk.

It should be noted that, preferably, the online playback device of the present invention can include a browser, a browser plug-in or other clients that may be used for online multimedia playback, etc. The online playback device of the present invention may be pre-installed in the user equipment by the manufacturer or the sales service provider of the user equipment, or may be downloaded to the user equipment from a server by the user. A person skilled in the art should understand that any devices that can accomplish the functions in the present invention, regardless of whether it is downloaded to the user equipment or not, shall be covered by the scope of protection of the present invention.

It should be noted that the present invention can be implemented by software and/or a combination of software and hardware. For example, various means of the present invention may be realized by using an application specific integrated circuit (ASIC) or any other similar hardware devices. In one embodiment, the software program of the present invention can be executed by a processor to accomplish the steps or functions described above. Similarly, the software program (including related data structures) of the present invention can be stored in a computer readable recording medium, for example, an RAM memory, a magnetic or optical driver or a floppy disk and similar devices. In addition, some of the steps or functions of the present invention can be realized by hardware, for example, a circuit that cooperates with the processor to execute the various steps or functions.

It would be apparent to a person skilled in the art that the present invention is not limited to the details of the exemplary embodiments described above, and the present invention can be achieved in other specific forms without departing from the spirit or essential features of the present invention. Accordingly, from all points, the embodiments should be considered as exemplary and non-limiting, and the scope of the present invention is defined by the appended claims rather than by the above description. Therefore, all variations that fall within the meaning and range of equivalent essentials of the claims are intended to be embraced within the scope of the present invention. The reference signs in the claims should not be regarded as limiting the related claims. In addition, it is apparent that the term “comprise” does not mean that other units or steps are excluded, and the singular does not mean that the plural is excluded. The multiple units or devices set forth in the system claims may also be implemented by one unit or device via software or hardware. The words “first”, “second”, etc. are used to represent names, rather than any specific order.

1. A method for online multimedia playback on user equipment, wherein the method comprises steps of:
(a) launching a second player when a playback instruction operation is intercepted, with the playback instruction operation executed by a user on playable multimedia displayed on a page, wherein the second player is different from a first player instructed by the page to play back the playable multimedia; and
(b) playing back the playable multimedia in the second player.

2. The method according to claim 1, wherein Step (a) comprises a step of:
launching the second player, without launching the first player, when the playback instruction operation is intercepted, with the playback instruction operation executed by the user on the playable multimedia displayed on a page.

3. The method according to claim 1, wherein the method further comprises steps of:
acquiring playback log information of the playable multimedia in the second player; and
providing the playback log information to a network device which is instructed by the page to receive the playback log information of the playable multimedia.

4. The method according to claim 3, wherein the playback log information of the playable multimedia comprises at least one of:
playback time information of the playable multimedia;
playback record information of advertisement information played in association with the playable multimedia; and
information of operations executed by the user on the playable multimedia.

5. The method according to claim 1, wherein the user equipment comprises a mobile device, and/or the page comprises a mobile page.

6. The method according to claim 5, wherein the mobile page is based on a HTML5 standard.

7. The method according to claim 1, wherein Step (b) comprises steps of:
(b1) acquiring playback address information of the playable multimedia; and
(b2) acquiring multimedia data corresponding to the playback address information and playing back the multimedia data in the second player.

8. The method according to claim 7, wherein Step (b1) comprises a step of:
parsing the page, and obtaining the playback address information of the playable multimedia on the basis of a video tag obtained by parsing.

9. A device for online multimedia playback on user equipment, comprising:
launching means, configured for launching a second player when a playback instruction operation is intercepted, with the playback instruction operation executed by a user on playable multimedia displayed on a page, wherein the second player is different from a first player instructed by the page to play back the playable multimedia; and
playback means, configured for playing back the playable multimedia in the second player.

10. The device according to claim 9, wherein the launching means comprises:
sub-launching means, configured for launching the second player without launching the first player, when a playback instruction operation is intercepted, with the playback instruction operation executed by the user on the playable multimedia displayed on a page.

11. The device according to claim 9, wherein the device comprises following means:
first acquisition means, configured for acquiring playback log information of the playable multimedia in the second player; and
provision means, configured for providing the playback log information to a network device which is instructed by the page to receive the playback log information of the playable multimedia.

12. The device according to claim 11, wherein the playback log information of the playable multimedia comprises at least one of:
playback time information of the playable multimedia;
playback record information of advertisement information played in association with the playable multimedia; and
information of operations executed by the user on the playable multimedia.

13. The device according to claim 9, wherein the user equipment comprises a mobile device, and/or the page comprises a mobile page.

14. The device according to claim 13, wherein the mobile page is based on a HTML5 standard.

15. The device according to claim 9, wherein the playback device comprises:
second acquisition means, configured for acquiring playback address information of the playable multimedia; and
third acquisition means, configured for acquiring multimedia data corresponding to the playback address information and playing back the multimedia data in the second player.

16. The device according to claim 15, wherein the second acquisition means comprises:
parsing means, configured for parsing the page and obtaining the playback address information of the playable multimedia on the basis of a video tag obtained by parsing.

17. (canceled)

18. (canceled)

19. (canceled)

20. An apparatus, wherein the apparatus comprises a memory and a processor, the memory is configured to store computer codes, and the processor is configured to execute the method according to claim 1 by executing the computer codes.

21. The method according to claim 2, wherein the method further comprises steps of:
acquiring playback log information of the playable multimedia in the second player; and
providing the playback log information to a network device which is instructed by the page to receive the playback log information of the playable multimedia.

22. The method according to claim 2, wherein Step (b) comprises steps of:
(b1) acquiring playback address information of the playable multimedia; and
(b2) acquiring multimedia data corresponding to the playback address information and playing back the multimedia data in the second player.

23. The method according to claim 3, wherein Step (b) comprises steps of:
(b1) acquiring playback address information of the playable multimedia; and
(b2) acquiring multimedia data corresponding to the playback address information and playing back the multimedia data in the second player.
